(19) United States
(12) Patent Application Publication
(10) Pub. No.: US 2026/0111268 A1
(43) Pub. Date: Apr. 23, 2026

(54) QUEUE LOCK IMPLEMENTATION WITH CROSS-CHIP LOCKING

(71) Applicant: INTERNATIONAL BUSINESS MACHINES CORPORATION, ARMONK, NY (US)

(72) Inventors: Lokesh Mohan Gupta, Tucson, AZ (US); Matthew G. Borlick, Tucson, AZ (US); Louis A. Rasor, Tucson, AZ (US); Todd C. Sorenson, Tucson, AZ (US)

(21) Appl. No.: 18/922,089

(22) Filed: Oct. 21, 2024

(51) Int. Cl. G06F 9/50

(52) U.S. Cl. CPC G06F 9/5022

(57) ABSTRACT

Provided are a computer implemented method, system, and computer program product for managing a lock to a computational resource. The processing units maintain queues associated with the processing units to queue processes in the processing units waiting for the lock. A first processing unit of the processing units determines whether the lock is available. The first processing unit adds an entry to a first queue within the first processing unit identifies a first process requesting the lock and indicates in a lock variable in the entry that the lock is not granted in response to determining that the lock is not available. The first process requesting the lock spins on the lock variable waiting for the lock variable to indicate that the lock is granted.

### BACKGROUND OF THE INVENTION

### 1. Field of the Invention

The present invention relates to a computer implemented method, system, and computer program product for a queue lock implementation with cross-chip locking.

### 2. Description of the Related Art

To synchronize access to a shared resource, a thread seeking to access the resource needs to obtain a lock for the shared resource, which grants the thread access to the resource. Other threads must wait for the lock to be released and granted to them in order to access the resource. One lock technique is to provide threads a spinlock when requesting access to the shared resource. A spinlock causes a thread trying to acquire the lock to wait in a loop, i.e., “spin, while repeatedly checking whether the lock is available. The thread will hold the spinlock until the thread determines the lock is available or until a time-out condition occurs.

Another locking technique is the use of a queue lock. With a queue lock, multiple threads seeking to acquire the same lock spin on unique memory locations indicated in an array or queue. All the memory locations are initialized to zero and the lock is granted to a thread by setting its corresponding memory location in the queue to one. On a lock release, the memory location for the next thread in the queue is set to one to pass the lock to the next thread. The queued requests for the lock are granted in a First-in-First-Out (FIFO) ordering.

### SUMMARY

Provided are a computer implemented method, system, and computer program product for managing a lock to a computational resource. The processing units maintain queues associated with the processing units to queue processes in the processing units waiting for the lock. A first processing unit of the processing units determines whether the lock is available. The first processing unit adds an entry to a first queue within the first processing unit identifies a first process requesting the lock and indicates in a lock variable in the entry that the lock is not granted in response to determining that the lock is not available. The first process requesting the lock spins on the lock variable waiting for the lock variable to indicate that the lock is granted.

Further provided are a computer implemented method, system, and computer program product for managing a lock to a computational resource. Processing units maintain queues associated with the processing units to queue requests from processes in the processing units requesting the lock. A first processing unit, comprising one of the processing units, acquires the lock. A start time is set to a current time in response to acquiring the lock. The lock is granted to a subset of processes, in a first queue of the queues associated with the first processing unit, that are initiated within a time threshold of the start time. The lock is transferred to a process in a second processing unit of the processing units in response to the subset of processes in the first queue releasing the lock.

### BRIEF DESCRIPTION OF THE DRAWINGS

FIG. 1 illustrates an embodiment of a computing environment.

FIG. 2 illustrates an embodiment of an I/O controller.

FIG. 3 illustrates an embodiment of lock information.

FIG. 4 illustrates an embodiment of a queue entry in lock queues in the processing units.

FIG. 5 illustrates an embodiment of operations performed by a process to acquire a lock.

FIG. 6 illustrates an embodiment of operations performed by a process to release a lock.

FIG. 7 illustrates a computing environment in which the components of FIG. 1 may be implemented.

### DETAILED DESCRIPTION

One problem with spinlocks is that an intervening thread may obtain the spinlock once released even though other threads have been spinning on the spinlock for a longer time. This occurs if the intervening thread requests the lock before the longer waiting threads attempt to acquire the spinlock after the spinlock has been released. Another problem with spinlocks is that all threads which want to acquire a lock must execute many atomic operations on a shared variable in shared memory. This results in cache invalidation because the local thread may store the lock locally in the processor, but the value of the lock may not be updated in memory.

A problem with current queue locks is that there is only one queue which is served in First-in-First-Out (FIFO) order. The queue may receive lock requests from threads on multiple processing units in multiple processor chips to acquire the lock. The cross-processing unit, i.e., cross-chip, lock requests to the queue may result in excessive lock request traffic over a bus interconnect to the shared queue in memory. This excessive lock request traffic has a negative impact on bus performance and latency.

Described embodiments provide improvements to computer technology for managing locks to computational resources by implementing a lock queue in each processing unit. Described embodiments provide a protocol for the different processing units to manage their lock queues. A lock queue, maintained by a processing unit, has entries for requests from processes initiated in the processing unit for a lock to a shared resource. This protocol allows each processing unit to manage lock requests internally in a local lock queue of the processing unit without having to communicate over the bus to a lock queue in shared memory.

Described embodiments further provide improvements to lock management computer technology by having a processing unit process multiple lock requests in the local lock queue before transferring the lock to a next processing unit having queued lock requests in another local lock queue. This improves lock request processing by allowing multiple lock requests to be processed in one lock queue locally without accessing the bus. This avoids expending time and computational resources to communicate with other processing units over the bus and update lock information in a shared memory for each lock request. In this way, lock requests are batched in one processing unit without having to communicate on the bus interface to process. Only after the processing unit completes batch processing of lock requests will the processing unit write, over the bus interface, an identifier of a next processing unit to be granted the lock to a lock owner field in the shared memory.

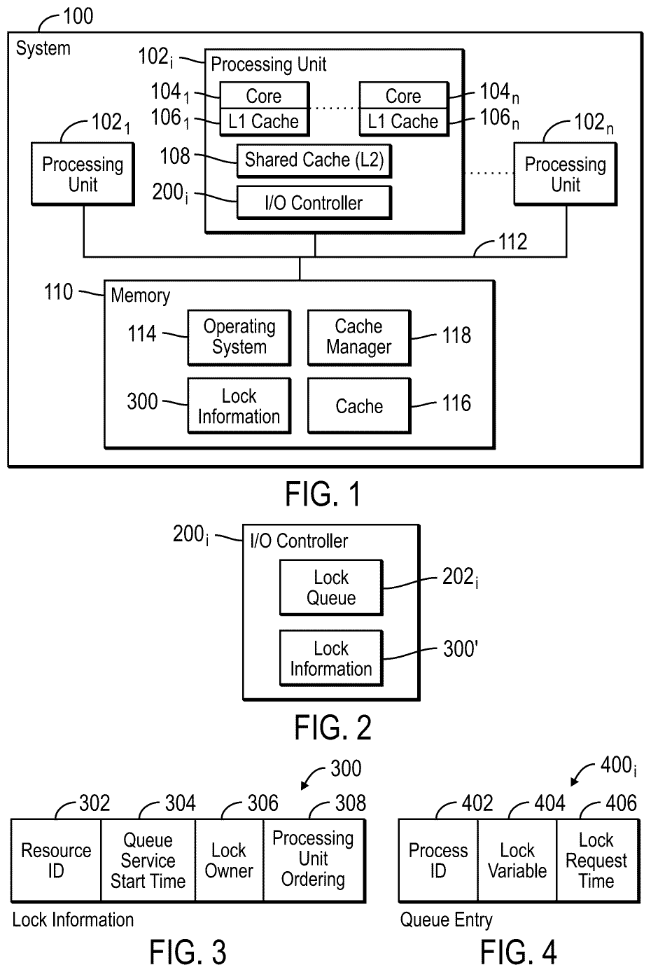

FIG. 1 illustrates an embodiment of a system 100 including a plurality of processing units 102₁, 102ᵢ . . . 102ₙ. Processing unit 102ᵢ refers to any one of the processing units 102₁ . . . 102ₙ or multiple of the processing units. Each of the processing units 102ᵢ may include a plurality of cores 104₁ . . . 104ₙ on a single integrated circuit substrate, i.e., chip. Each core 104₁ . . . 104 has an L1 cache 106₁ . . . 106ₙ. The cores 104₁ . . . 104ₙ share a shared cache (L2) 108. An Input/Output (I/O) controller 200ᵢ includes the components to communicate with I/O devices, such as a memory 110, a bus interface 112, video controller, network cards, and any other I/O devices. The I/O controller 200ᵢ may comprise the processing unit 102ᵢ chipset. There may be further levels of caches, such as additional cache levels within the processing units 102ᵢ.

The memory 110 includes an operating system 114 and lock information 300 having information on locks to computational resources. The computational resources protected by the locks may comprise cache lines in a cache 116. A cache manager 118 manages the cache 116. The cache manager 118 may maintain cache coherency by flushing modified cache lines stored in an L1 cache 106ᵢ or shared cache 108 to the cache 116. After updating the cache 116, the cache manager 118 may invalidate the cache line in all other processing units to cause the processing units storing the cache line to read the updated cache line from the cache 116.

The I/O controller 200ᵢ includes a lock queue 202ᵢ for a processing unit 102ᵢ having entries for processes, e.g., threads, waiting for a lock for a particular computational resource, such as a cache line or other resource. Each processing unit 102ᵢ has a lock queue 202ᵢ to separately queue processes initiated within the cores 104₁ . . . 104ₙ of the processing unit 102ᵢ requesting the lock There may be a separate lock queue 202ᵢ within the processing unit 102ᵢ for each different lock requested by a process within the processing unit 102ᵢ. The I/O controller 200ᵢ may maintain a copy of the lock information 300′ maintained in the main memory 110 to use locally. There may be multiple instances of lock information 300, 300′ for different locks for different computational resources.

FIG. 3 illustrates an embodiment of the lock information 300 or 300ᵢ, which may include: a resource identifier (ID) 302 comprising an identifier of the computational resource protected by the lock; a queue service start time 304 indicating when the lock was granted to a processing unit 102ᵢ indicated in a lock owner 306 field; and a processing unit ordering 308 indicating an order in which processing units are selected to receive the lock. The processing unit ordering 308 may allow for round-robin assignment of the lock to processing units.

FIG. 4 illustrates an embodiment of an instance 400ᵢ of an entry in the lock queue 202ᵢ for a processing unit 102ᵢ, and includes: a process ID 402 identifying the process executing in the processing unit 102ᵢ; a lock variable 404 indicating whether the process 402 is granted the lock, e.g., a “1” indicating the lock is granted and a “0” indicating the lock is not granted; and a lock request time 406 indicating a time the process 402 requested the lock or was added to the lock queue 202ᵢ.

The L1 cache 106ᵢ and shared cache 108 may comprise a high-speed data storage layer which stores a subset of cache lines in the main memory 110 cache 116. The cache and shared cache are typically transient in nature, so that future requests for that data are served up faster than is possible by accessing the primary storage location of the data. The L1 cache 106ᵢ, shared cache 108, and memory 110 may comprise a volatile or non-volatile memory device, such as a Static Random Access Memory (SRAM), Dynamic Random Access Memory (DRAM), eDRAM (embedded DRAM). Other embodiments may utilize phase change memory (PCM), Magnetoresistive random-access memory (MRAM), Spin Transfer Torque (STT)-MRAM, a ferroelectric random-access memory (Efram), nanowire-based non-volatile memory, and Direct In-Line Memory Modules (DIMMs), NAND storage, e.g., flash memory, Solid State Drive (SSD) storage, non-volatile RAM, etc.

The I/O controller 200ᵢ logic may be implemented in circuitry in a semiconductor device, such as am Application Specific Integrated Circuit (ASIC), Field Programmable Gate Array (FPGA). Alternatively, the I/O controller logic may be implemented in a processor executing computer readable instructions stored in a memory.

The described processes that request the lock may be implemented in code executed by the processing unit 200ᵢ cores 104₁ . . . 104ₙ.

In FIG. 1, the processing units are shown as multi-core processing units. In alternative embodiments, the processing units may comprise a single core processor. In described embodiments, the I/O controller 200ᵢ is shown as implemented on the processing unit 102ᵢ, such as with a system-on-a-chip implementation. In alternative embodiments, the I/O controller 200ᵢ may be maintained in a separate chipset for the processing unit 102ᵢ.

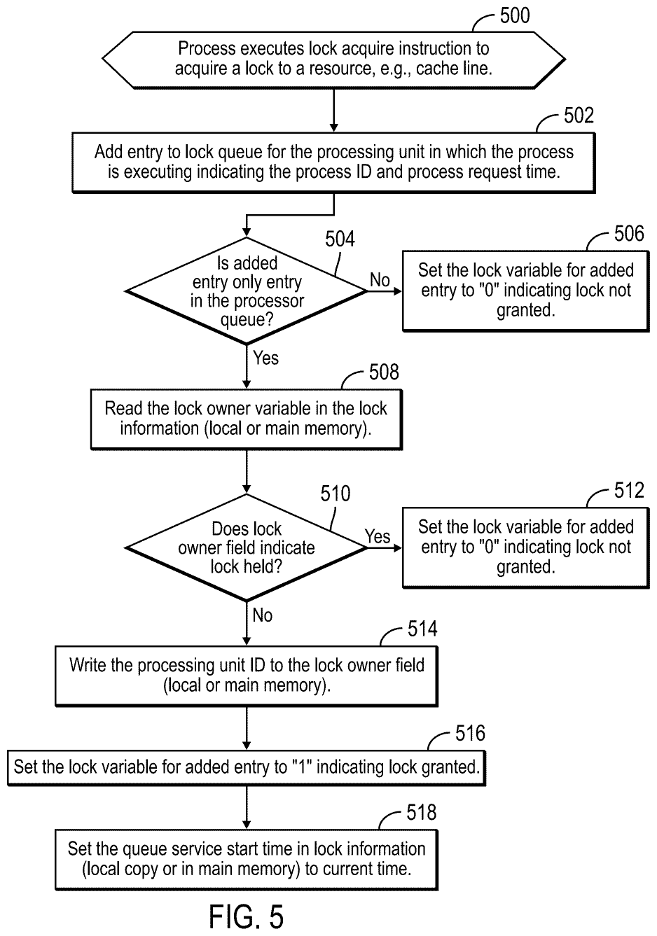

FIG. 5 illustrates an embodiment of operations performed by a process executing in a core of a processing unit 102ᵢ to obtain a lock for a computational resource. The operations of FIG. 5 may be implemented in a lock acquire instruction executed by a process. In response to a request from a process executing in the processing unit, e.g., processing unit 102ᵢ, an entry 400ᵢ is added (at block 502) to the lock queue, such as lock queue 202ᵢ, for the processing unit in which the process is executing. The added entry 400ᵢ indicates the process ID 402 and lock request time 406 the process requested the lock. If (at block 504) the added entry 400ᵢ is not the only entry in the lock queue, then the lock variable 404 is set (at block 506) to indicate the lock is not granted. If (at block 504) the added entry 400ᵢ is the only entry in the processor queue, then the I/O controller reads the lock owner field 306 in lock information 300′ for the lock in the I/O controller or the lock information 300 in the main memory 110. The cache manager 118 may maintain cache coherency to ensure that a copy of lock information 300′ updated in a local cache, e.g., L1 cache 106ᵢ or shared cache 108, is copied to the lock information 300 in the main memory 110.

If (at block 510) the lock owner field 306 indicates the lock is held, then the lock variable 404 is set (at block 512) to indicate the lock is not granted. If (at block 510) the lock owner field 306 indicates the lock is not held, then the process writes (at block 514) the processing unit ID to the lock owner field 306. The lock variable 404 in the added entry 400ᵢ is set (at block 516) to indicate the lock is granted. The queue service start time 304, in the local copy or in the main memory, is set (at block 518) to a current time.

With the embodiment of FIG. 5, a process executing an instruction to acquire a lock will add an entry to a lock queue on which to spin while waiting for the lock variable to be changed to indicate the lock is granted. In this way, processes do not need to issue reads over the bus to spin on the lock variable. Further, process requests for the lock variable may be serviced locally in the I/O controller for the processing unit in which the process executes without communicating with the operating system over the bus. In this way, read requests over the bus interface are minimized.

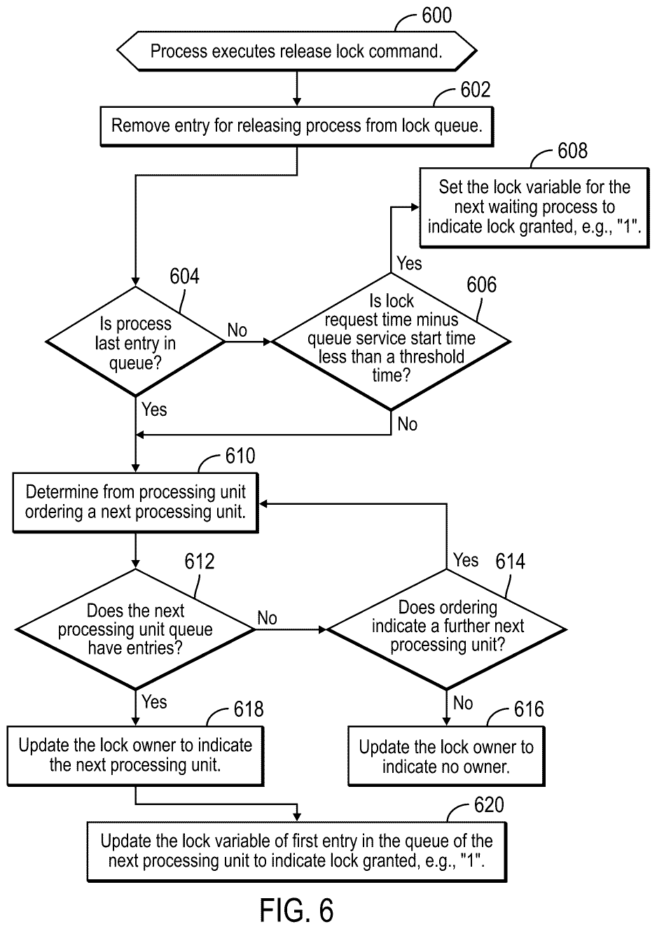

FIG. 6 illustrates an embodiment of operations performed by a process to execute an instruction to release the lock after completing usage of the computational resource protected by the lock. Alternatively, the operations of FIG. 6 may be performed by the I/O controller or in the operating system. Upon the process executing (at block 600) an instruction to release the lock, the process removes (at block 602) the entry 400ᵢ for the process from the processor queue. If (at block 604) the removed entry 400ᵢ for the process is the last entry in the processor queue, i.e., the queue is not empty after removing the entry, then a determination is made (at block 606) whether the lock request time 406 minus queue service start time 304 is less than a threshold time. If so, then the lock variable 404 for the next waiting process is set (at block 608) to indicate the lock is granted. In this way, once the lock is assigned to the processing unit, a subset of queued processes in the queue whose lock request time 406 is within a threshold time of the queue service start time 304 are assigned the lock before passing the lock to another processing unit.

If (at block 604) the process is the last entry in the process queue or if (at block 606) the lock request time 406 minus queue service start time 304 is not less than the threshold time, then the process determines (at block 610) from the processing unit ordering 308 in the local lock information 300′ a next processing unit to receive the lock. If (at block 612) the lock queue of the next processing unit does not have any entries of processes waiting for the lock, then the process goes back to block 614 to determine a further next processing unit according to the ordering. If (at block 614) the ordering does not indicate a further next processing unit, then the process updates (at block 616) the lock owner field to indicate there is no owning processing unit. The operation at block 616 happens when all processing units in the ordering have been considered. In an alternative embodiment, the process may continue going through the ordering until one of the examined lock queues in the processing units has a process waiting for the lock.

If (at block 612) the next processing unit does have one or more entries 400ᵢ, then the process updates (at block 618) the lock owner field 306 to indicate the next processing unit as the owner. The process may further update (at block 620) the lock variable in the first entry in the process queue for the next processing unit to indicate the lock is granted. The process spinning on the lock variable in the first entry in the process queue will read the updated lock variable and then access the resource protected by the lock.

With the embodiment of FIG. 6, one processing unit may process multiple queued lock requests within a time threshold of when that processing unit was granted the lock. This allows multiple lock requests to be serviced without having to communicate across the bus to release the lock for each request in the queue. Further, the processing units act independently to select the next processing unit to grant the lock and transfer the lock to the next processing unit by updating the first entry in the lock queue of the next processing unit. This all happens without having to communicate over the bus to the operating system in the main memory to manage and update locks. In this way, traffic on the main bus is reduced and the operating system is not interrupted by the processing of the lock requests within the processing units and the transferring of the lock to another processing unit.

The operations of FIGS. 5 and 6 are described as being performed by processes executing in the cores of the processing units. In alternative embodiments, the lock acquire and lock release operations may be performed in code implemented in the I/O controller or a lock manager in the memory.

Described embodiments further reduce traffic on the bus because only the next processing unit being granted the lock is notified of the lock transfer and not other of the processing units.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

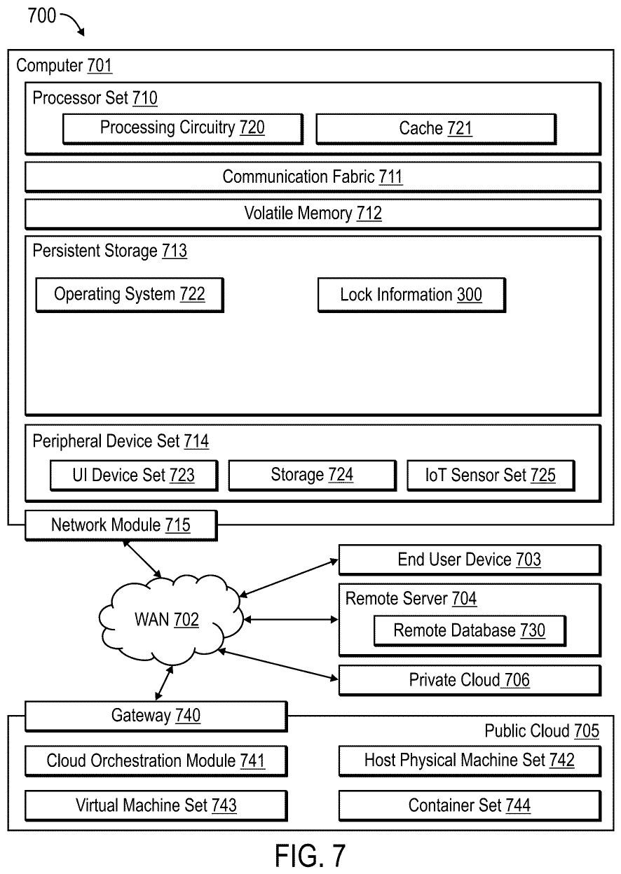

With respect to FIG. 7, computing environment 700 contains an example of an environment for the execution of at least some of the computer code involved in performing the inventive methods, such as the firmware or code implemented in the I/O controller 200ᵢ. The computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and lock information 300, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. The processing circuitry 720 may comprise the processing units 102₁ . . . 102ₙ, including the I/O controllers 200ᵢ to perform the lock management operations for the processing units 102ᵢ. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer-readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 721 and the other storage media discussed below. The program instructions, and associated data, are accessed by processor set 710 to control and direct performance of the inventive methods.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer-readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

CLOUD COMPUTING SERVICES AND/OR MICROSERVICES (not separately shown in FIG. 7): private and public clouds 706 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for managing a lock to a computational resource, comprising:
maintaining, by processing units, queues associated with the processing units to queue requests from processes in the processing units requesting the lock;
acquiring, by a first processing unit comprising one of the processing units, the lock;
setting a start time to a current time in response to acquiring the lock;
granting the lock to a subset of processes, in a first queue of the queues associated with the first processing unit, that are initiated within a time threshold of the start time; and
transferring the lock to a process in a second processing unit of the processing units in response to the subset of processes in the first queue releasing the lock.

2. The computer implemented method of claim 1, wherein the granting the lock to the subset of processes comprises granting the lock to a first process of the subset of processes and then granting the lock to each process in the subset of processes in response to a previous process of the subset of processes releasing the lock.

3. The computer implemented method of claim 1, wherein the start time comprises a first start time, and wherein the transferring the lock to the process in the second processing unit comprises:
selecting the second processing unit from an ordering indicating an order in which the processing units are selected to acquire the lock;
setting a second start time, for a second queue of the queues, associated with the second processing unit; and
granting the lock to a subset of processes in the second queue that are initiated within a time threshold of the second start time; and
transferring the lock to a process in a third processing unit of the processing units in response to the subset of processes in the second queue releasing the lock.

4. The computer implemented method of claim 1, wherein the first queue includes a lock variable for each process in the first queue indicating one of that the process holds the lock and does not hold the lock, wherein the granting the lock to the subset of processes in the first queue comprises:
setting a first lock variable for a first process in the first queue to indicate the first process holds the lock in response to the first processing unit acquiring the lock; and
for each considered process in the subset of processes in the first queue following the first process, setting a lock variable for the considered process to indicate the considered process holds the lock in response to a previous process preceding the considered process in the first queue releasing the lock.

5. The computer implemented method of claim 1, wherein the first queue includes a lock variable for each process in the first queue indicating one of that the process holds the lock and does not hold the lock, wherein the granting the lock to the subset of processes in the first queue comprises:
setting lock variables for processes in the first queue to indicate the processes do not hold the lock in response to adding the processes to the first queue;
setting a first lock variable for a first process in the first queue to indicate the first process holds the lock in response to the first processing unit acquiring the lock; and
for each considered process in the subset of processes in the first queue following the first process, setting a lock variable for the considered process to indicate the considered process holds the lock in response to a previous process preceding the considered process in the first queue releasing the lock.

6. The computer implemented method of claim 1, wherein the queues are maintained within the processing units, and wherein the lock is transferred to the second processing unit by the first processing unit writing an identifier of the second processing unit to a lock owner variable in a main memory accessed by the processing units.

7. A computer implemented method for managing a lock to a computational resource, comprising:
maintaining, by processing units, queues associated with the processing units to queue processes in the processing units waiting for the lock;
determining, by a first processing unit of the processing units, whether the lock is available; and
adding, by the first processing unit, an entry to a first queue within the first processing unit identifying a first process requesting the lock and indicating in a lock variable in the entry that the lock is not granted in response to determining that the lock is not available, wherein the first process requesting the lock spins on the lock variable waiting for the lock variable to indicate that the lock is granted.

8. The computer implemented method of claim 7, further comprising:
determining, by a second process executing in a second processing unit holding the lock, that there is no additional process in a second queue in the second processing unit waiting for the lock; and
writing, by the second process, to a lock variable in the entry in the first queue for the first process in the first processing unit, indicating that the first process holds the lock in response to determining that there is no additional process in the second queue waiting for the lock.

9. The computer implemented method of claim 7, further comprising:
determining, by a second process executing in a second processing unit holding the lock, that there is a third process, executing in the second processing unit, indicated in a second queue, waiting for the lock;
determining, by the second process, whether a difference of a time the third process was added to the second queue and a start time of when the second processing unit was provided the lock is less than a time threshold in response to determining that there is the third process in the second queue; and
writing, by the second process, to a lock variable in an entry in the second queue for the third process, indicating that the third process holds the lock in response to determining the difference of the time the third process was added to the second queue and the start time is within the time threshold.

10. The computer implemented method of claim 7, further comprising:
receiving a request, at the first processing unit, for the lock from the first process; and
determining whether there is an entry in the first queue for a process waiting for the lock, wherein the first processing unit determines whether the lock is available in response to the determining that there is no entry in the first queue for a process waiting for the lock.

11. The computer implemented method of claim 7, wherein the entry comprises a first entry, the lock variable comprises a first lock variable, further comprising:
receiving a request, at the first processing unit, for the lock from a second process executing in the first processing unit;
determining whether there is another entry in the first queue for another process waiting for the lock in response to receiving the request; and
adding, by the first processing unit, a second entry to the first queue identifying the second process and indicating in a second lock variable in the second entry that the lock is not available in response to determining that there is another entry in the first queue for a process waiting for the lock, wherein the second process spins on the second lock variable waiting for the second lock variable to indicate that the lock is available.

12. A system for managing a lock to a computational resource, comprising:
a first processing unit having a first queue to queue requests from processes in the first processing unit requesting the lock;
a second processing unit having a second queue to queue requests from processes in the second processing unit requesting the lock;
wherein the first processing unit performs operations, the operations comprising:
acquiring the lock;
setting a start time to a current time in response to acquiring the lock;
granting the lock to a subset of processes in the first queue that are initiated within a time threshold of the start time; and
transferring the lock to a process in the second processing unit in response to the subset of processes in the first queue releasing the lock.

13. The system of claim 12, further comprising:
a third processing unit;
wherein the start time comprises a first start time, and wherein the transferring the lock to the process in the second processing unit comprises selecting the second processing unit from an ordering indicating an order in which the processing units are selected to acquire the lock,
wherein the second processing unit performs operations, the operations comprising:
setting a second start time, for a second queue of the queues, associated with the second processing unit; and
granting the lock to a subset of processes in the second queue that are initiated within a time threshold of the second start time; and
transferring the lock to a process in the third processing unit in response to the subset of processes in the second queue releasing the lock.

14. The system of claim 12, wherein the first queue includes a lock variable for each process in the first queue indicating one of that the process holds the lock and does not hold the lock, wherein the granting the lock to the subset of processes in the first queue comprises:
setting a first lock variable for a first process in the first queue to indicate the first process holds the lock in response to the first processing unit acquiring the lock; and
for each considered process in the subset of processes in the first queue following the first process, setting a lock variable for the considered process to indicate the considered process holds the lock in response to a previous process preceding the considered process in the first queue releasing the lock.

15. The system of claim 12, wherein the first queue includes a lock variable for each process in the first queue indicating one of that the process holds the lock and does not hold the lock, wherein the granting the lock to the subset of processes in the first queue comprises:
setting lock variables for processes in the first queue to indicate the processes do not hold the lock in response to adding the processes to the first queue;
setting a first lock variable for a first process in the first queue to indicate the first process holds the lock in response to the first processing unit acquiring the lock; and
for each considered process in the subset of processes in the first queue following the first process, setting a lock variable for the considered process to indicate the considered process holds the lock in response to a previous process preceding the considered process in the first queue releasing the lock.

16. The system of claim 12, wherein the lock is transferred to the second processing unit by the first processing unit writing an identifier of the second processing unit to a lock owner variable in a main memory accessed by the first and the second processing units.

17. A system for managing a lock to a computational resource, comprising:
processing units having queues associated with the processing units to queue processes in the processing units waiting for the lock,
wherein a first processing unit of the processing units includes a first queue of the queues to queue processes in the first processing unit waiting for the lock, wherein the first processing unit performs:
determining whether the lock is available; and
adding an entry to the first queue identifying a first process requesting the lock and indicating in a lock variable in the entry that the lock is not granted in response to determining that the lock is not available, wherein the first process requesting the lock spins on the lock variable waiting for the lock variable to indicate that the lock is granted.

18. The system of claim 17, wherein a second processing unit of the processing units includes a second queue of the queues, wherein a second process executing in the second processing unit holding the lock performs:
determining that there is no additional process in the second queue waiting for the lock; and
writing to a lock variable in the entry in the first queue for the first process in the first processing unit, indicating that the first process holds the lock in response to determining that there is no additional process in the second queue waiting for the lock.

19. The system of claim 17, wherein a second processing unit of the processing units includes a second queue of the queues, wherein a second process executing in the second processing unit holding the lock performs:
determining that there is a third process, executing in the second processing unit, indicated in a second queue, waiting for the lock;
determining whether a difference of a time the third process was added to the second queue and a start time of when the second processing unit was provided the lock is less than a time threshold in response to determining that there is the third process in the second queue; and
writing to a lock variable in an entry in the second queue for the third process, indicating that the third process holds the lock in response to determining the difference of the time the third process was added to the second queue and the start time is within the time threshold.

20. The system of claim 17, wherein the first processing unit further performs:
receiving a request for the lock from the first process; and
determining whether there is an entry in the first queue for a process waiting for the lock, wherein the first processing unit determines whether the lock is available in response to the determining that there is no entry in the first queue for a process waiting for the lock.

21. The system of claim 17, wherein the entry comprises a first entry, the lock variable comprises a first lock variable, wherein the first processing unit further performs:
receiving a request for the lock from a second process executing in the first processing unit;
determining whether there is another entry in the first queue for another process waiting for the lock in response to receiving the request; and
adding a second entry to the first queue identifying the second process and indicating in a second lock variable in the second entry that the lock is not available in response to determining that there is another entry in the first queue for a process waiting for the lock, wherein the second process spins on the second lock variable waiting for the second lock variable to indicate that the lock is available.

22. A computer program product for managing a lock to a computational resource, the computer program product comprising a computer readable storage medium having computer readable program code embodied therein that when executed by processing units including a first processing unit performs operations, the operations comprising:
maintaining queues associated with the processing units to queue requests from processes in the processing units requesting the lock;
acquiring, by the first processing unit, the lock;
setting, by the first processing unit, a start time to a current time in response to acquiring the lock;
granting, by the first processing unit, the lock to a subset of processes, in a first queue of the queues associated with the first processing unit, that are initiated within a time threshold of the start time; and
transferring the lock to a process in a second processing unit of the processing units in response to the subset of processes in the first queue releasing the lock.

23. The computer program product of claim 22, wherein the start time comprises a first start time, and wherein the transferring the lock to the process in the second processing unit comprises:
selecting, by the first processing unit, the second processing unit from an ordering indicating an order in which the processing units are selected to acquire the lock;
setting, by the second processing unit, a second start time, for a second queue of the queues, associated with the second processing unit; and
granting, by the second processing unit, the lock to a subset of processes in the second queue that are initiated within a time threshold of the second start time; and
transferring, by the second processing unit, the lock to a process in a third processing unit of the processing units in response to the subset of processes in the second queue releasing the lock.

24. The computer program product of claim 22, wherein the first queue includes a lock variable for each process in the first queue indicating one of that the process holds the lock and does not hold the lock, wherein the granting the lock, by the first processing unit, to the subset of processes in the first queue comprises:
setting a first lock variable for a first process in the first queue to indicate the first process holds the lock in response to the first processing unit acquiring the lock; and
for each considered process in the subset of processes in the first queue following the first process, setting a lock variable for the considered process to indicate the considered process holds the lock in response to a previous process preceding the considered process in the first queue releasing the lock.

25. The computer program product of claim 22, wherein the first queue includes a lock variable for each process in the first queue indicating one of that the process holds the lock and does not hold the lock, wherein the granting the lock, by the first processing unit, to the subset of processes in the first queue comprises:
setting lock variables for processes in the first queue to indicate the processes do not hold the lock in response to adding the processes to the first queue;
setting a first lock variable for a first process in the first queue to indicate the first process holds the lock in response to the first processing unit acquiring the lock; and
for each considered process in the subset of processes in the first queue following the first process, setting a lock variable for the considered process to indicate the considered process holds the lock in response to a previous process preceding the considered process in the first queue releasing the lock.
